(19) United States
(12) Patent Application Publication
(10) Pub. No.: US 2009/0088110 A1
(43) Pub. Date: Apr. 2, 2009

(54) RADIO FREQUENCY RECEIVER ARCHITECTURE

(75) Inventors: Axel Schuur, Mountain View, CA (US); Nianwei Xing, Mountain View, CA (US); David H. Shen, San Jose, CA (US); Chien-Meen Hwang, San Jose, CA (US); Ann P. Shen, Saratoga, CA (US); Niranjan Talwalkar, Karnataka (IN)

Correspondence Address: FISH & RICHARDSON P.C., P.O. BOX 1022, MINNEAPOLIS, MN, 55440-1022, US

(73) Assignee: NANOAMP SOLUTIONS, INC. (CAYMAN), Santa Clara, CA (US)

(21) Appl. No.: 12/236,888

(22) Filed: Sep. 24, 2008

Related U.S. Application Data
(60) Provisional application No. 60/975,745, filed on Sep. 27, 2007.

(51) Int. Cl. H04B 1/16

(52) U.S. Cl. 455/209

(57) ABSTRACT

A radio frequency receiver includes a passive mixer configured to receive and RF signal and a low input impedance circuit configured to receive the output of the passive mixer.

### CROSS-REFERENCE TO RELATED APPLICATIONS

This application claims the benefit of priority from U.S. Provisional Application entitled “Radio Frequency Receiver Architecture,” Application No. 60/975,745 filed Sep. 27, 2007, the disclosure of which is incorporated by reference.

### TECHNICAL FIELD

This disclosure relates to radio frequency (RF) transceivers.

### BACKGROUND

Various wireline or wireless communication systems, such as Wideband Code Division Multiple Access (WCDMA), are full-duplex systems, e.g., they call for simultaneously receiving and transmitting information during operation. As a consequence, the transmit signal may leak through the duplexer or other circuitry and appear as a blocking signal at the receiver input. Because of the possible leaked transmission signals and/or other blocking signals, intermodulation products may fall into the same frequency range as a received wanted signal and reduce the quality of the received wanted signal.

### SUMMARY

In general, some implementations include features for a method of operating a mixer subsystem. The method includes receiving a radio frequency (RF) signal at an input of a passive mixer, and mixing the received RF signal with an output signal of a local oscillator using the passive mixer to generate a downconverted signal. The method includes receiving the downconverted signal at an input of a transimpedance amplifier that includes one or more feedback impedances coupled between the input of the transimpedance amplifier and an output of the transimpedance amplifier, in which the input of the transimpedance amplifier includes one or more bipolar transistors as input devices.

These and other implementations can optionally include one or more of the following features. The feature of receiving the RF signal at the input of the passive mixer can include receiving the RF input signal at the input of the passive mixer from an output of a low noise amplifier (LNA) via one or more capacitors configured to filter out a direct current (DC) component in the RF signal. The LNA can include an inductor-capacitor (LC) tank circuit or a resistor-capacitor network. The LNA can be single-ended or differential. The passive mixer can include one or more current-mode switches. The passive mixer can include one or more transistors. The feature of mixing the received RF signal with the output signal of a local oscillator using the passive mixer to generate a downconverted signal can include downconverting the RF input signal to an intermediate or a baseband frequency. The transimpedance amplifier may be configured to amplify the downconverted signal with a gain. The one or more feedback impedances can be configured to filter leaked transmit signals or blocking signals. The transimpedance amplifier can be configured to have an input impedance value on the order of ohms. The transimpedance amplifier can include a source-follower amplifier. The mixer and transimpedance amplifier can be configured for a Wideband Code Division Multiple Access (WCDMA) communication system. The mixer or transimpedance amplifier can include metal-oxide-semiconductor-field-effect-transistors (MOSFET) and the input bipolar transistors can be “parasitic” bipolar transistors of the MOSFET. The mixer or transimpedance amplifier can be formed using bipolar-CMOS (BiCMOS) or Silicon-Germanium (SiGe) process technology.

In general, some implementations feature a circuit that includes a passive mixer configured to receive a radio frequency (RF) input signal, receive a local oscillator signal, and mix the RF input signal with the local oscillator signal to generate a downconverted signal. The circuit includes a transimpedance amplifier including an input configured to receive the downconverted signal and one or more feedback impedances coupled between the input of the transimpedance amplifier and an output of the transimpedance amplifier. The input of the transimpedance amplifier includes one or more bipolar transistors as input devices.

These and other implementations can optionally include one or more of the following features. The circuit can have a low noise amplifier (LNA) configured to output the RF signal to the passive mixer via one or more capacitors configured to filter out a direct current (D)C) component in the RF signal. The LNA can include an inductor-capacitor (LC) tank circuit or a resistor-capacitor network. The LNA can be single-ended or differential. The passive mixer can include one or more current-mode switches. The passive mixer can include one or more transistors. In order to generate a downconverted signal, the passive mixer can be configured to downconvert the RF signal to a baseband frequency. The transimpedance amplifier can be configured to amplify the downconverted signal with a gain. The one or more feedback impedances can be configured to filter leaked transmit signals or blocking signals. The amplifier can be configured to have an input impedance value on the order of ohms. The transimpedance amplifier can include a source-follower amplifier. The passive mixer and the transimpedance amplifier can be configured for a Wideband Code Division Multiple Access (WCDMA) communication system. The passive mixer or transimpedance amplifier can be formed from metal-oxide-semiconductor-field-effect-transistors (MOSFET) and the input bipolar transistors of the transimpedance amplifier can be “parasitic” bipolar transistors. The passive mixer or the transimpedance amplifier can be formed from bipolar-CMOS (1BiCMOS) or Silicon-Germanium (SiGe) process technology.

In general, some implementations include features for a full-duplex transceiver. The full-duplex transceiver includes a transmit path configured to provide a transmit signal to a duplexer, a low noise amplifier configured to input a received signal from the duplexer and output a first amplified signal, and a passive current-mode down-converting mixer configured to input the first amplified signal and output a down-converted signal. The full-duplex transceiver also includes a transimpedance amplifier configured to input the down-converted signal and output a second amplified signal, and a low pass filter configured to input the second amplified signal and output a filter signal.

These and other implementations can optionally include one or more of the following features. The transimpedance amplifier can include bipolar transistors as input devices. The low noise amplifier can include an inductor-capacitor (LC) tank circuit or a resistor-capacitor network. The lownoise amplifier can be single-ended or differential. The passive mixer can include one or more current-mode switches. The passive mixer can include one or more transistors. In order to generate a down-converted signal, the passive mixer can be configured to down-convert the RF signal to a baseband frequency. The transimpedance amplifier can be configured to is amplify the down-converted signal with a gain. The transimpedance amplifier can include one or more feedback impedances that are configured to filter leaked transmit signals or blocking signals. The transimpedance amplifier can be configured to have an input impedance value on the order of ohms. The transimpedance amplifier can include a source-follower amplifier. The passive mixer and the transimpedance amplifier can be configured for a Wideband Code Division Multiple Access (WCDMA) communication system. The passive mixer or transimpedance amplifier can be formed from metal-oxide-semiconductor-field-effect-transistors (MOSFET). The passive mixer or the transimpedance amplifier can be formed from bipolar-CMOS (BiCMOS) or Silicon-Germanium (SiGe) process technology. The input bipolar transistors of the transimpedance amplifier can be “parasitic” bipolar transistors.

The details of one or more implementations are set forth in the accompanying drawings and the description below. Other features will be apparent from the description and drawings, and from the claims.

### DESCRIPTION OF THE DRAWINGS

FIG. 1 is a schematic of an example of a full-duplex communication system transceiver

FIG. 2 is a frequency diagram of an example of a frequency arrangement in a full-duplex communication system.

FIG. 3 is a schematic of an example of a receiver architecture including an off-chip RF filter.

FIG. 4 is a schematic of an example of a receiver architecture including an on-chip RF filter.

FIG. 5 is a schematic of an example of a receiver architecture including a passive current-mode mixer and a transimpedance amplifier.

FIG. 6 is a schematic of an example of a transimpedance amplifier.

### DETAILED DESCRIPTION

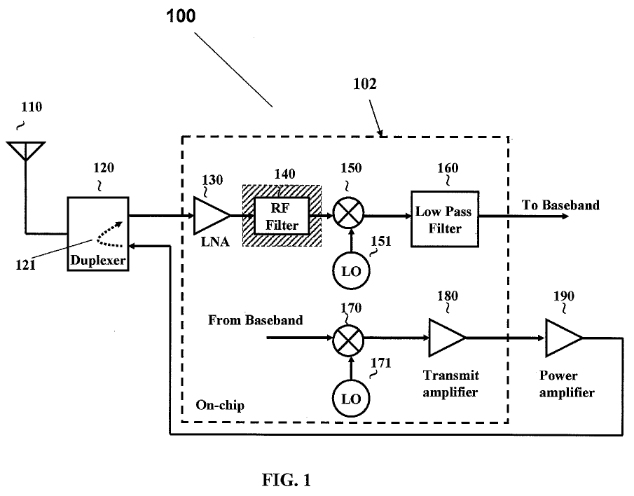

FIG. 1 is a schematic of an example of a full-duplex communication system transceiver 100 that may be used in, for example, WCDMA systems. The transceiver includes a receive path including a low noise amplifier (LNA) 130, an RF filter 140, a down-converting mixer 150, and a low-pass filter. A signal may be received at an antenna 110 and then pass through a duplexer 120. The signal then may pass onto an integrated structure 102 to the receive path. There it may first enter the LNA 130, then pass through the RF filter 140 and through the down-converting mixer 150. The signal then may be further filtered by the low-pass filter 160 before being sent to the baseband for subsequent processing. The RF filter 140 may be included as part of the integrated structure 102 (on-chip) or may be external to the integrated structure 102 (off-chip).

The transceiver 100 also includes a transmit path including an up-converting mixer 170, a transmit amplifier 180 and a power amplifier 190, which may be external to the integrated structure 102. The output of the power amplifier may also be connected to the antenna 110 via the duplexer 120. The output power of the power amplifier 190 may be very high as compared to the required minimum signal level in the receive path. The transmit signal and the receive signal may be at different frequencies. The duplexer may provide some isolation between the output of the power amplifier 190 and the input of the LNA 130. But since this isolation may not be infinite, some of the transmit signal may leak into the input of the LNA via leakage 121 in the duplexer 120. Furthermore, duplexers of high isolation can be very costly.

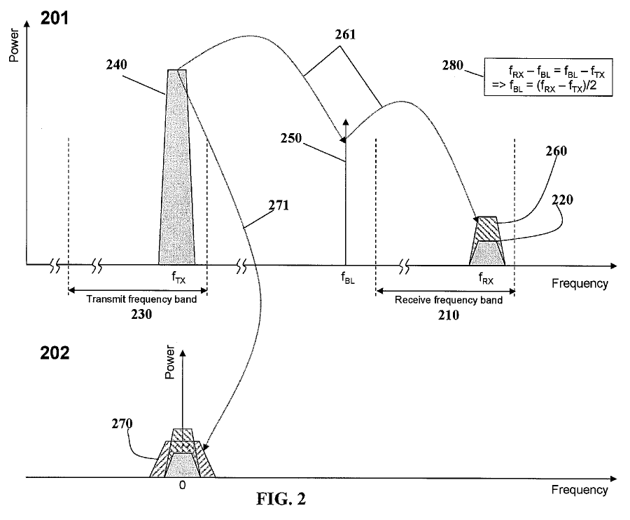

FIG. 2 is a frequency diagram illustrating an example of a possible frequency arrangement in a full-duplex communication system, such as transceiver 100. The first diagram 201 displays a possible combination of signals at the input of a receiver circuit, for example, at the input of LNA 130. A receive frequency band 210 includes a wanted receive signal 220. A transmit frequency band 230 includes a transmit signal 240 which may have leaked to a receiver input, for example, through the duplexer 120. The diagram 201 also shows a blocking signal 250 that may be located at a frequency between the frequency of the wanted receive signal 220 and that of the transmit signal 240.

Certain components in a receive path (e.g. the LNA 130 and the mixer 150) may exhibit 3^{rd}-order nonlinearity. When passing through components exhibiting such 3^{rd}-order nonlinearity, the transmit signal 240 and the blocking signal 250 may generate a 3^{rd}-order intermodulation product 260 that may coincide and corrupt the wanted receive signal 220, as indicated by the arrows 261. Such a situation may occur if the frequency relation between the wanted receive signal 220, the transmit signal 240, and the blocking signal 250 is as specified by the formulae 280.

Certain components in the receive path (e.g., the mixer 150) may further exhibit 2^{nd}-order nonlinearity. When the leaked transmit signal 240 passes through components exhibiting such 2^{nd}-order nonlinearity, various frequency components of the leaked transmit signal 240 may interact and generate a 2^{nd}-order intermodulation product 270 as indicated by the arrow 271. This intermodulation product 270 may appear at 0 frequency. Particularly, in a direct conversion receiver topology, such a situation may cause the intermodulation product 270 to coincide with the wanted receive signal 220 after it has been down-converted by a down-converting mixer (e.g., down-converting mixer 150). This situation is shown in the frequency diagram 202.

Certain wireless specifications (e.g., the WCDMA Specification) define the amount of acceptable degradation of the received signal due to a leaked transmit signal and/or other blocking signals. One solution to prevent or minimize unacceptable degradation of the received signal quality due to leaked transmit signals and/or other blocking signals is to provide additional RF filtering to attenuate the leaked transmit signal or other blocking signal. Doing so may relax the 2^{nd} and 3^{rd} order linearity requirements of downstream components that would otherwise be needed to meet the specification.

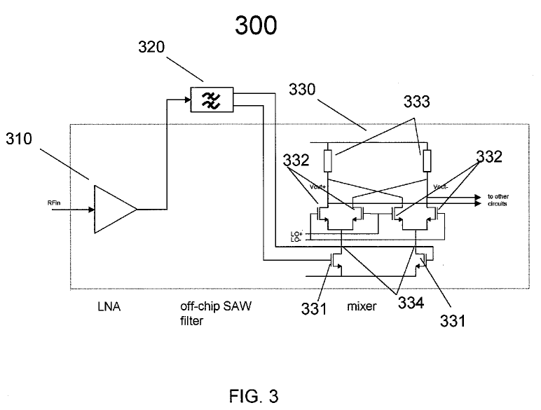

FIG. 3 is a schematic of an example of a receiver architecture 300 including an off-chip RF filter to attenuate a leaked transmit signal and/or other blocking signals. The receiver architecture 300 includes an LNA 310, a surface acoustic wave (SAW) filter 320, and an active mixer 330. The SAW filter 320 is included between the lownoise amplifier LNA 310 and the mixer 330 in order to filter the leaked transmit signal and/or any other blocking signals using mechanical waves and a piezoelectric crystal.

In the active mixer 330, the RF signal from the SAW filter 320 is first converted to current by the NMOS input transistors 331 before passing through the switching pairs 332. The signal that has been down converted in frequency may then form an output voltage via the load impedances 333.

A number of features of the active mixer 330 may degrade the linearity of mixer 330. For instance, the NMOS input transistors 331 may degrade the overall linearity of the mixer circuit since, in an NMOS transistor, the output drain current may depend on the square of the input voltage, compared to, in a perfectly linear device, the output current depending directly on the input voltage.

Furthermore, the output impedance of the input NMOS transistors 331 may not be infinite. As a result, the voltage at the drain nodes 334 of the NMOS transistors 331 may vary over time. This in turn may cause the drain-to-source voltage of the switching transistors 332 to also vary over time. This variation may cause further nonlinearity since the drain current of an NMOS device also depends on the drain-to-source voltage. The use of the SAW filter 320 may counteract the effects that these non-linearity may have on the degradation of the received signal due to leaked transmit signals and/or other blocking signals.

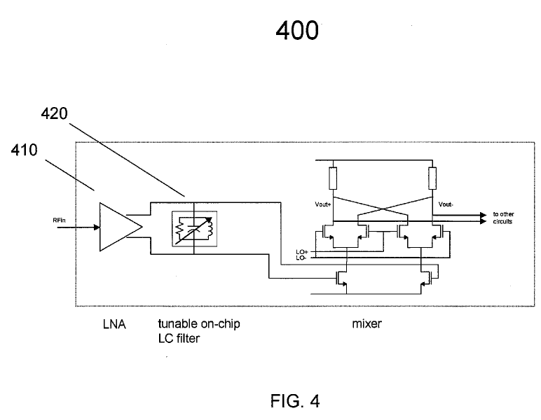

FIG. 4 is a schematic of an example of a receiver architecture 400 including an on-chip RF filter to attenuate a leaked transmit signal and/or other blocking signals. In particular, the receiver architecture 400 includes an LNA 410, an inductor-capacitor (LC) tank 420, and an active mixer 430. The LC tank 420 can be an on-chip filter included to filter the leaked transmit signal and/or other blocking signals. As shown, the LNA 410 outputs the received RF signal to the LC tank 420 which filters the RF signal prior to the input of the mixer 430. The active mixer 430 operates in the same manner as mixer 330.

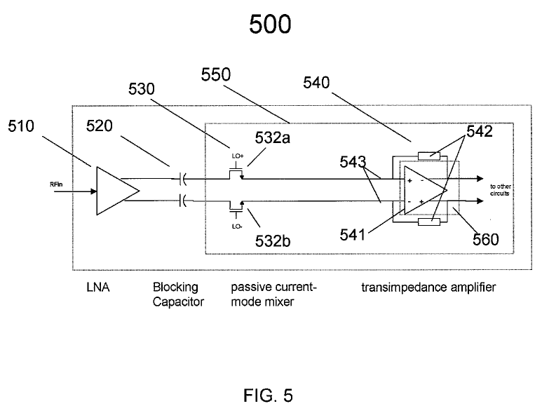

FIG. 5 is an example schematic of a receiver architecture 500 that does not include additional RF filtering to filter leaked transmit signals or other blocking signals. The receiver architecture 500 includes an LNA 510, blocking capacitors 520, and a mixer subsystem 550. The mixer subsystem includes a passive current-mode down converting mixer 530 and a transimpedance amplifier 540 that uses bipolar transistors as input devices.

The received signal, RFin, is received by the LNA 510 from, for example, duplexer 120. The LNA 520 amplifies the received signal and outputs an amplified differential signal to the passive current-mode down-converting mixer 530 through blocking capacitors 520. While the LNA 510 is shown as having a single-ended input and a differential output, the input and output of LNA 510 can be single-ended or differential. Likewise, the received signal RFin can be single-ended or differential. The LNA 510 can use LC tank circuits or resistive circuits.

The down-converting passive mixer 530 mixes the amplified signal with a local oscillator signal (LO) to down-convert the amplified signal. The output of the down-converting mixer 530 is provided to a transimpedance amplifier 540 to convert the current signal to an amplified voltage signal.

The topology of the passive current-mode mixer 530 can be selected based on the requirements of a communication system protocol relating to leaked transmit signals and/or other blocking signals and the expected blocking signal and/or leaked transmit signal. For instance, a passive current-mode mixer 530 can be selected or designed to meet particular 2^{nd} and/or 3^{rd} order input referred intercept point (IIP) characteristics (e.g., IIP2 and IIP3) that are sufficient to fulfill a communication system specification (e.g., WCDMA) relating to blocking signals and leaked transmit signals without the need for any additional filtering between the LNA 510 and the mixer 530. As a particular example, the mixer subsystem 550 can be designed to meet a minimum IIP2 and IIP3 of approximately 50 dBm and −4 dBm, respectively, to allow additional filtering to be eliminated.

In the specific example shown in FIG. 5, the passive current-mode mixer 530 includes transmission gates 532a and 532b (formed, e.g., with MOS transistors) that are driven by a local oscillator (LO) signal. The mixer subsystem 550 with a passive current-mode mixer 530 may exhibit 2^{nd} and/or 3^{rd} order intercept point characteristics (i.e., IIP2 and IIP3) that are significantly higher than those of a mixer subsystem with an active mixer such as the mixer 430. This performance may be due to a number of differences relating to how the received signal may pass through the mixer structure 530. In particular, the passive mixer 530 has no input device that converts an input signal into current and that may exhibit nonlinearity.

Compared with the active mixers 330 and 430, the passive mixer 530 may have significantly lower gain (in practicality, it may have gain loss) because the mixer 530 does not include an input device that provides gain. The transimpedance amplifier 540 that terminates the passive mixer 530 can compensate for this lower gain. The transimpedance amplifier 540 may include an operational amplifier 541 configured into a feedback system with feedback impedances 542. The gain of the transimpedance amplifier can be fixed or variable and can, for example, be set in the order of 50 dB Ohms. In additional to the amplifying function, the feedback impedances 542 of the transimpedance amplifier 540 may further be configured to provide a filtering function that attenuates unwanted signals such as blocking signals or transmit leakage.

The input stage of the transimpedance amplifier 540 can use bipolar transistors as input devices to improve input signal sensitivity, which can eliminate the need for an additional amplifier before the mixer 530 to boost the gain of the RF input signal to the mixer 530.1 n some implementation, the bipolar transistors are formed by standard complementary-metal-oxide-semiconductor (CMOS) fabrication process technology, or often-called “parasitic” bipolar transistor. In other implementations, the bipolar transistors are formed by bipolar-CMOS (BiCMOS) or by Silicon-Germanium (SiGe) fabrication process technologies.

In addition, this bipolar input stage can improve the system component linearity. Particularly, using bipolar transistors may provide the transimpedance amplifier 540 with a low impedance, in the order of a few ohms, at its input 543. Such a low input impedance may help reduce or minimize the passive mixer drain-to-source voltage variation over time thereby reducing or minimizing the voltage variation at the output of the mixer 530 over time, improving the linearity of the mixer 530.

Furthermore, using bipolar transistors 610 instead of MOS transistors at the input stage of the transimpedance amplifier 540, may improve the mixer noise figure by several dB without degrading other performance aspects of the transimpedance amplifier 540 (e.g. the gain performance).

DC blocking capacitors 520 may be inserted between the LNA 510 and the mixer 530 to prevent a DC offset at the output of the LNA 510 from passing into the mixer 530 from where it may leak through to the mixer output and degrade the quality of the signal. Furthermore, the capacitors 520 may prevent a DC current from flowing through the mixer 530. Such a DC current may result in increased device noise, as noise generation in a MOS transistor may be increase with the increase of its DC drain-to-source current.

Instead of an operational amplifier 541, other implementations may use other circuit components to provide a low impedance at the output of the mixer 530. One example is a common-gate circuit using MOS transistors.

The receiver architecture 500 can eliminate the use of filtering to remove unwanted signals. This may reduce cost and used board space because, for example, a SAW filter is not used or because an LC filter and its associated tuning and/or calibration circuitry is not needed.

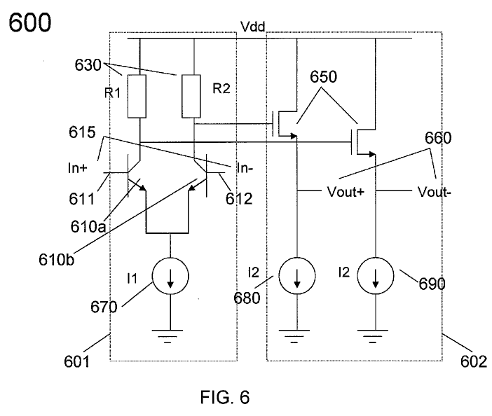

FIG. 6 shows a schematic of an example operational amplifier 600 that can be used as the amplifier 560 in the transimpedance amplifier 540. A differential input signal 615 can enter the input terminals 611 and 612 of the operational amplifier 600, which are coupled to the base terminals of bipolar transistors 610a and 610b. A current source 670 provides a bias current for the input stage 601 for setting the direct current (DC) operation point for transistors 610a and 610b. The differential current output signal of the input stage 601 is converted to a differential voltage output signal by load resistors 630. The output voltage signal is coupled to the gate terminals of MOS transistors 650 of the output stage 602 of the amplifier 600.

The output stage 602 of the amplifier 600 uses MOS transistors 650. In some implementations, the output stage 602 of the operational amplifier 600 can be configured as a source-follower or voltage-follower which transforms impedances. Current sources 680 and 690 provide bias currents for transistors 650 of the output stage 602. The differential output voltage signal Vout 660 of the amplifier 600 is output on the source terminals of the MOS transistors 650.

Other passive mixer subsystems can be used. Particularly, other passive mixer topologies that can meet the system linearity requirements and other low input impedance amplifiers can be used.

The disclosed techniques can be used with wireless or wireline communication systems. For example, the disclosed techniques can be used with receivers, transmitters, and transceivers, such as the receiver, transmitter, and/or transceiver architectures for superheterodyne receivers, image-rejection (e.g., Hartley, Weaver) receivers, zero-intermediate frequency (IF) receivers, low-IF receivers, and other types of receivers and transceivers for wireless and wireline technologies. The techniques described may be particularly useful in WCDMA full-duplex receivers, and may allow for the removal of an RE filter following a LNA in such receivers.

In some implementations, the positions of circuit components can be exchanged from the disclosed figures with minimal change in circuit functionality. Various topologies for circuit models can also be used. The exemplary designs may use various process technologies, such as CMOS or BiCMOS (Bipolar-CMOS) process technology, or Silicon Germanium (SiGe) technology. The circuits can be single-ended or fully-differential circuits.

The system can include other components. Some of the components can include computers, processors, clocks, radios, signal generators, counters, test and measurement equipment, function generators, oscilloscopes, phase-locked loops, frequency synthesizers, phones, wireless communication devices, and components for the production, storage, and transmission of audio, video, and other data. The number, arrangement, and order of the stages and/or circuits can vary. Also, the number of controllable steps, as well as the steps sizes of each of the stages of gain can also vary. A number of implementations have been described. Nevertheless, it will be understood that various modifications may be made. Accordingly, other implementations are within the scope of the following claims.

What is claimed is:

1. A method of operating a mixer subsystem comprising:
receiving a radio frequency (RF) signal at an input of a passive mixer;
mixing the received RF signal with an output signal of a local oscillator using the passive mixer to generate a downconverted signal; and
receiving the downconverted signal at an input of a transimpedance amplifier that includes one or more feedback impedances coupled between the input of the transimpedance amplifier and an output of the transimpedance amplifier, wherein the input of the transimpedance amplifier includes one or more bipolar transistors as input devices.

2. The method of claim 1 wherein receiving the RF signal at the input of the passive mixer includes receiving the RF input signal at the input of the passive mixer from an output of a low noise amplifier (LNA) via one or more capacitors configured to filter out a direct current (DC) component in the RF signal.

3. The method of claim 2 wherein the LNA comprises an inductor-capacitor (LC) tank circuit or a resistor-capacitor network.

4. The method of claim 2 wherein the LNA is single-ended or differential.

5. The method of claim 1 wherein the passive mixer includes one or more current-mode switches.

6. The method of claim 1 wherein the passive mixer includes one or more transistors.

7. The method of claim 1 wherein mixing the received RF signal with the output signal of a local oscillator using the passive mixer to generate a downconverted signal includes downconverting the RF input signal to an intermediate frequency or a baseband frequency.

8. The method of claim 1 wherein the transimpedance amplifier is configured to amplify the downconverted signal with a gain.

9. The method of claim 1 wherein the one or more feedback impedances are configured to filter leaked transmit signals or blocking signals.

10. The method of claim 1 wherein the transimpedance amplifier is configured to have an input impedance value on the order of ohms.

11. The method of claim 1 wherein the transimpedance amplifier includes a source-follower amplifier.

12. The method of claim 1 wherein the passive mixer and the transimpedance amplifier are configured for a Wideband Code Division Multiple Access (WCDMA) communication system.

13. The method of claim 1 wherein the passive mixer or the transimpedance amplifier is includes metal-oxide-semiconductor-field-effect-transistors (MOSFET) and the one or more bipolar transistors are parasitic bipolar transistors.

14. The method of claim 1 wherein the passive mixer or the transimpedance amplifier is formed using bipolar-CMOS (BiCMOS) or Silicon-Germanium (SiGe) process technology.

15. A circuit comprising:
a passive mixer configured to receive a radio frequency (RF) input signal, receive a local oscillator signal, and mix the RF input signal with the local oscillator signal to generate a downconverted signal; and
a transimpedance amplifier including an input configured to receive the downconverted signal and one or more feedback impedances coupled between the input of the transimpedance amplifier and an output of the transimpedance amplifier, wherein the input of the transimpedance amplifier includes one or more bipolar transistors as input devices.

16. The circuit of claim 15 further comprising:
a low noise amplifier (LNA) configured to output the RF signal to the passive mixer via one or more capacitors configured to filter out a direct current (DC) component in the RF signal.

17. The circuit of claim 16 wherein the LNA comprises an inductor-capacitor (LC) tank circuit or a resistor-capacitor network.

18. The circuit of claim 16 wherein the LNA is single-ended or differential.

19. The circuit of claim 15 wherein the passive mixer includes one or more current-mode switches.

20. The circuit of claim 15 wherein the passive mixer includes one or more transistors.

21. The circuit of claim 15 wherein, to generate a downconverted signal, the passive mixer is configured to downconvert die RF signal to an intermediate frequency or a baseband frequency.

22. The circuit of claim 15 wherein the transimpedance amplifier is configured to is configured to amplify the downconverted signal with a gain.

23. The circuit of claim 15 wherein the one or more feedback impedances are configured to filter leaked transmit signals or blocking signals.

24. The circuit of claim 15 wherein the amplifier is configured to have an input impedance value on the order of ohms.

25. The circuit of claim 15 wherein the transimpedance amplifier includes a source-follower amplifier.

26. The circuit of claim 15 wherein the passive mixer and the transimpedance amplifier are configured for a Wideband Code Division Multiple Access (WCDMA) communication system.

27. The circuit of claim 15 wherein the passive mixer or the transimpedance amplifier is formed from metal-oxide-semiconductor-field-effect-transistors (MOSFET) and the one or more bipolar transistors of the transimpedance amplifier are parasitic bipolar transistors.

28. The circuit of claim 15 wherein the passive mixer or the transimpedance amplifier is formed from bipolar-CMOS (BiCMOS) or Silicon-Germanium (SiGe) process technology.

29. A full-duplex transceiver comprising:
a transmit path configured to provide a transmit signal to a duplexer;
a low noise amplifier configured to input a received signal from the duplexer and output a first amplified signal;
a passive current-mode down-converting mixer configured to input the first amplified signal and output a down-converted signal;
a transimpedance amplifier configured to input the down-converted signal and output a second amplified signal; and
a low pass filter configured to input the second amplified signal and output a filter signal.

30. The transceiver of claim 29 wherein the transimpedance amplifier comprises bipolar transistors as input devices.

31. The transceiver of claim 29 wherein the low noise amplifier comprises an inductor-capacitor (LC) tank circuit or a resistor-capacitor network.

32. The transceiver of claim 29 wherein the low noise amplifier is single-ended or differential.

33. The transceiver of claim 29 wherein the passive mixer includes one or more current-mode switches.

34. The transceiver of claim 29 wherein the passive mixer includes one or more transistors.

35. The transceiver of claim 29 wherein, to generate a down-converted signal, the passive mixer is configured to down-convert the RF signal to an intermediate frequency or a baseband frequency.

36. The transceiver of claim 29 wherein the transimpedance amplifier is configured to amplify the down-converted signal with a gain.

37. The transceiver of claim 29 wherein the transimpedance amplifier includes one or more feedback impedances configured to filter leaked transmit signals or blocking signals.

38. The transceiver of claim 29 wherein the transimpedance amplifier is configured to have an input impedance value on the order of ohms.

39. The transceiver of claim 29 wherein the transimpedance amplifier includes a source-follower amplifier.

40. The transceiver of claim 29 wherein the passive mixer and the transimpedance amplifier are configured for a Wideband Code Division Multiple Access (WCDMA) communication system.

41. The transceiver of claim 29 wherein the passive mixer or the transimpedance amplifier is formed from metal-oxide-semiconductor-field-effect-transistors (MOSFET).

42. The circuit of claim 29 wherein the passive mixer or the transimpedance amplifier is formed from bipolar-CMOS (BiCMOS) or Silicon-Germanium (SiGe) process technology.

43. The circuit of claim 30 wherein the input bipolar transistors of the transimpedance amplifier are parasitic bipolar transistors,
